(19) United States
(12) Patent Application Publication
(10) Pub. No.: US 2008/0062324 A1
(43) Pub. Date: Mar. 13, 2008

(54) Chroma/Luma Delay Adjustment

(76) Inventor: Dongsheg Wu, Hainesport, NJ (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/466,552

(22) Filed: Aug. 23, 2006

(51) Int. Cl. H04N 7/01; H04N 5/04

(52) U.S. Cl. 348/624; 348/914; 348/500; 348/441

(57) ABSTRACT

In a system for synchronizing video signals using a sampled signal having a sampling cycle, the system includes a coarse offset module configured to receive a first input signal and a second input signal and to alter an offset of the first and second input signals to produce a first intermediate signal and a second intermediate signal offset relative to each other by an integer multiple of the sampling cycle and the system further includes a fine offset module coupled to the coarse offset module to receive the first and second intermediate signals and configured to alter an offset between the first and second intermediate signals relative to each other by an amount less than the sampling cycle to produce a first output signal and a second output signal.

### BACKGROUND

Today, many types of video sources are connected to video displays such as DVD players, VCRs, digital video recorders (DVRs), and set-top cable boxes. Video sources provide chrominance (chroma) and luminance (luma) information to a display, which the display uses to generate an image for a viewer. Analog video sources are typically connected to a display using one of several types of analog connections. The analog connection couples the video source to the display and can use various quantities of wires to transmit the chroma and luma information. For example, a composite video connection uses a single wire to transmit the chroma and luma information, an S-Video connection uses two wires to transmit the chroma and luma information, and a component video connection (e.g., YPbPr) uses three wires to transmit the chroma and luma information to a display (with the chroma split into two separate wires).

When the chroma and luma information is split over multiple paths (e.g., in an S-Video connection) image degradation can occur when the two signals are not substantially synchronized (e.g., aligned in time domain). For example, color bleeding, ghosting, fuzzy images, and/or shifted images can occur when the chroma and luma information are not synchronized. The synchronization loss between the chroma and luma signals can be caused by, for example, differences in the length of each respective transmission path, and/or differences in processing delay in each signal path. Because the cause of the synchronization loss is often hardware related, the synchronization loss can be estimated and/or measured for specific hardware configurations.

### SUMMARY

In a system for synchronizing video signals using a sampled signal having a sampling cycle, the system includes a coarse offset module configured to receive a first input signal and a second input signal and to alter an offset of the first and second input signals to produce a first intermediate signal and a second intermediate signal offset relative to each other by an integer multiple of the sampling cycle and the system further includes a fine offset module coupled to the coarse offset module to receive the first and second intermediate signals and configured to alter an offset between the first and second intermediate signals relative to each other by an amount less than the sampling cycle to produce a first output signal and a second output signal.

Implementations of the invention may include one or more of the following features. The fine offset module includes an interpolator. The interpolator is configured to resample the first and second intermediate signals. The interpolator is configured to use polyphase interpolation. The interpolator is configured to use N input samples of the first intermediate signal to produce a single sample of the first output signal, and configured to use N input samples of the second intermediate signal to produce a single sample of the second output signal. N can be equal to 10. The fine offset module includes a synchronizer configured to synchronize the loading of input samples of the first intermediate signal and the second intermediate signal into the interpolator. The fine offset module includes a synchronizer configured to synchronize a phase increment between respective pairs of samples of the first and second output signals. The fine offset module includes a synchronizer configured to delay an output sample of the first output signal until a corresponding output sample of the second output signal is ready to be output.

In general, in another aspect, the invention provides a method for synchronizing video signals using a sampled signal having a sampling cycle, the method including receiving a first input signal and a second input signal at a coarse offset module, producing a first intermediate signal and a second intermediate signal by altering an offset of the first and second input signals, the first and second intermediate signals being offset relative to each other by an integer multiple of a sampling cycle, and producing a first output signal and a second output signal by altering an offset between the first and second intermediate signals relative to each other by an amount less than the sampling cycle.

Implementations of the invention may include one or more of the following features. Producing a first output signal and a second output signal includes interpolating the first and second output signals. 12. The method further includes resampling the first intermediate signal. Interpolating the first and second output signals includes interpolating the first and second output signals using polyphase interpolation. Producing the first and second output signals includes using N input samples of the first intermediate signal to produce a single sample of the first output signal, and includes using N input samples of the second intermediate signal to produce a single sample of the second output signal. Producing the first and second output signals includes using 10 input samples of the first intermediate signal to produce a single sample of the first output signal, and includes using 10 input samples of the second intermediate signal to produce a single sample of the second output signal. The method further includes synchronizing a phase increment between respective pairs of samples of the first and second output signals. The method further included delaying an output sample of the first output signal until a corresponding output sample of the second output signal is ready to be output.

Various aspects of the invention may provide one or more of the following capabilities. Synchronization (e.g., alignment in time) loss between chroma and luma signals can be compensated (e.g., counteracted). Chroma and luma signals can be resampled and delayed. Chroma and luma signals can be delayed by an amount less than the sampling period of the sampled chroma and luma signals. The quantity of hardware used to delay a selected one of the chroma and luma signals can be reduced.

These and other capabilities of the invention, along with the invention itself, will be more fully understood after a review of the following figures, detailed description, and claims.

### BRIEF DESCRIPTION OF THE FIGURES

FIG. 1 is a block diagram of a precision delayline system.

FIG. 2 is a timing diagram of luma and chroma input samples and luma and chroma output samples.

FIG. 3 is a schematic diagram of output samples' phases relative to two input samples.

FIG. 4 is a block diagram of an interpolator shown in FIG. 1.

FIG. 5 is another timing diagram of luma and chroma input samples and luma and chroma output samples.

FIG. 6 is another timing diagram of luma and chroma input samples and luma and chroma output samples.

FIG. 7 is a block flow diagram of a process of providing precision delay using the system shown in FIG. 1.

### DETAILED DESCRIPTION

Embodiments of the invention provide techniques for adjusting delays of portions of a video signal. For example, a chroma/luma delay adjustment unit includes hierarchical delaylines including polyphase interpolators. The delay adjustment unit includes a coarse delayline module and a precision delayline module. The coarse delayline module receives incoming chroma and luma signals and performs a coarse delay adjustment using multiplexers and a buffer. The output of the coarse delayline module is provided to the precision delayline module. The precision delayline module performs precision delay adjustment at a more precise resolution than the coarse delayline module. The precision delayline uses interpolators and a sample synchronizer to perform precision delay adjustment. The invention can be used, for example, to intentionally unsynchronize the chroma and luma signal to preemptively compensate for synchronization loss caused by other components. Other embodiments are within the scope of the invention.

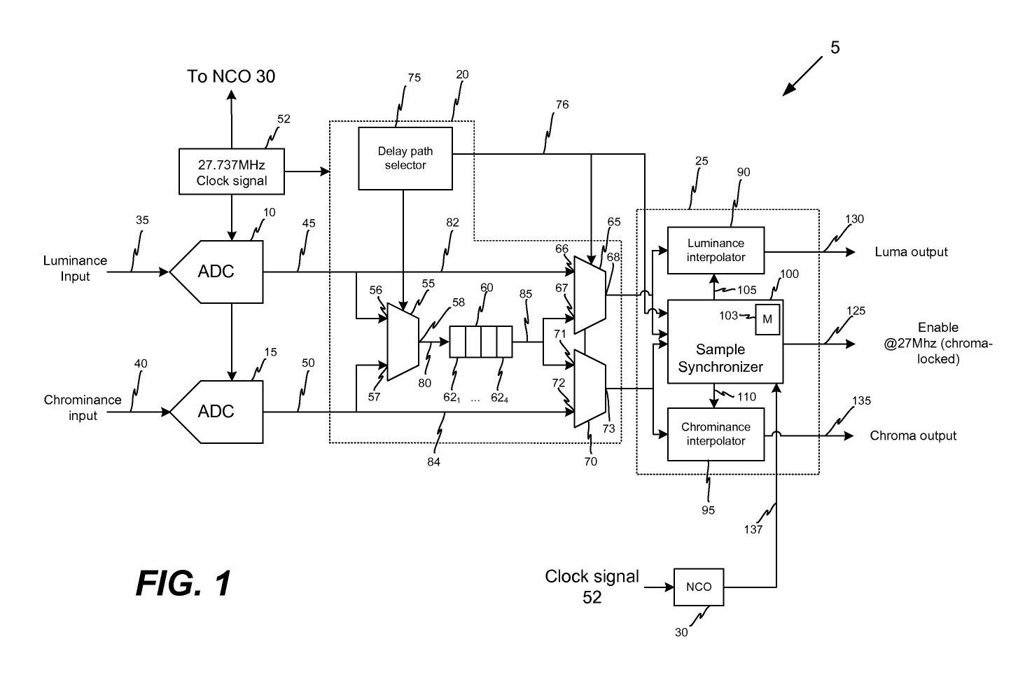

Referring to FIG. 1, a delay adjustment/resampling system 5 includes analog to digital converters (“ADCs”) 10 and 15, a coarse delay delayline module 20, and a precision delayline module 25. The ADCs 10 and 15 are configured to receive an analog luma signal 35 and an analog chroma signal 40, respectively. The ADC 10 is configured to convert the luma signal 35 into a digital luma signal 45 and provide the signal 50 to the coarse delayline module 20. The ADC 15 is configured to convert the chroma signal 40 into a digital chroma signal 50 and provide the signal 50 to the coarse delayline module 20. The ADCs 10 and 15 are configured to sample the signals 35 and 40 at a frequency of 27.737 MHz (using a clock signal 52), although other frequencies can be used. While the ADCs 10 and 15 are shown as using the same sampling rate, other configurations are possible (e.g., the ADC 10 can sample luma signal 35 at a different frequency than the ADC 15 samples the chroma signal 40). The ADCs 10 and 15 can be omitted if the luma signal 35 and the chroma signal 40 are digital signals.

The coarse delayline module 20 includes a multiplexer 55, a buffer 60, multiplexers 65 and 70, a delay path selector 75, and signal paths 80 and 85. The multiplexer 55 is a 2×1 multiplexer that includes inputs 56 and 57, and an output 58. The buffer 60 is memory, such as a shift register RAM, and includes four memory locations 62₁ through 62₄, although other quantities of memory locations are possible. The multiplexer 65 is a 2×1 multiplexer that includes inputs 66 and 67, and an output 68. The multiplexer 70 is a 2×1 multiplexer that includes inputs 71 and 72, and an output 73. While 2×1 multiplexers have been described, multiplexers with other configurations (e.g., 4×1, 2×2) can be used. The delay path selector 75 can be, for example, a processor such as a state machine, or a programmable processor. The coarse delayline module 20 is coupled to receive, and configured to operate using, the clock signal 52 (e.g., the sampling clock), although other clock signals can be used. The multiplexer 55 is configured to receive the luma signal 45 via the input 56 and the chroma signal 50 via the input 57. The multiplexer 55 is coupled to the delay path selector module 75. The delay path selector module 75 is configured to control which of the inputs 56 and 57 are coupled to the output 58 to provide either the luma signal 45 or the chroma signal 50 to the output 58. The output 58 is coupled to the buffer 60 via the signal path 80. The buffer 60 is configured to delay the signal present on the signal path 80 for a predetermined amount of τ, where τ is an integer multiple of the inverse of a frequency of the clock signal 52. Thus, if the multiplexer 55 provides the signal 45 to the buffer 60 via the signal path 80, the luma signal 45 will be delayed a time τ relative to the chroma signal 50 on an undelayed path 84. Likewise, if the multiplexer 55 provides the signal 50 to the buffer 60 via the signal path 80, the chroma signal 50 will be delayed a time τ relative to the luma signal 45 on an undelayed path 82.

The buffer 60 is coupled and configured to provide the delayed version of the luma signal 45 or the delayed version of the chroma signal 50 to the multiplexers 65 and 70 via the signal path 85. The multiplexer 65 is coupled and configured to receive the luma signal 45 from the ADC 10 on the undelayed path 82 via the input 66 and to receive the signal provided by the buffer 60 via the signal path 85 and the input 67. The multiplexer 70 is coupled and configured to receive the chroma signal 50 from the ADC 15 on the undelayed path 84 via the input 72 and to receive the signal provided by the buffer 60 via the signal path 85 and the input 71. The multiplexer 65 is configured to, using the signal provided from the delay path selector 75, couple the input 66 to the output 68, or to couple the input 67 to the output 68. The multiplexer 70 is configured to, using a signal provided from the delay path selector 75, couple the input 71 to the output 73, or to couple the input 72 to the output 73. For example, the multiplexer 65 can be configured to provide the undelayed luma signal 45 on the path 82 to the output 68, while the multiplexer 70 can be configured to provide a delayed version of the chroma signal 50 (via the buffer 60) to the output 73. If no coarse delay adjustment is desired, the multiplexer 65 will provide the undelayed luma signal 45 on the path 82 to the output 68, and the multiplexer 70 will provide the undelayed chroma signal 50 on the path 84 to the output 73.

The precision delayline module 25 includes a luma interpolator 90, a chroma interpolator 95, a sample synchronizer 100, and connections 105, and 110. The interpolators 90 and 95 are 256-phase polyphase interpolation filters, although other interpolators can be used. The sample synchronizer 100 is a processor such as a state machine and/or a microprocessor capable of executing computer readable code stored on a computer readable medium, e.g., memory 103. The interpolators 90 and 95 are coupled and configured to receive a signal from the multiplexers 65 and 70, respectively. The interpolators 90 and 95 are further coupled to receive control signals from the sample synchronizer 100 via the connections 105 and 110, respectively. The sample synchronizer is coupled to the delay path selector 75 via a connection 76. The sample synchronizer 100 is configured to provide precision delay to a selected one (or both) of the luma signal 45 and the chroma signal 50. The sample synchronizer 100 is configured to provide, via an enable clock output 125, an enable signal indicating when a pair of output samples is produced by the interpolators 90 and 95. The sample synchronizer 100 includes appropriate hardware, firmware, and/or software to implement the functions described below.

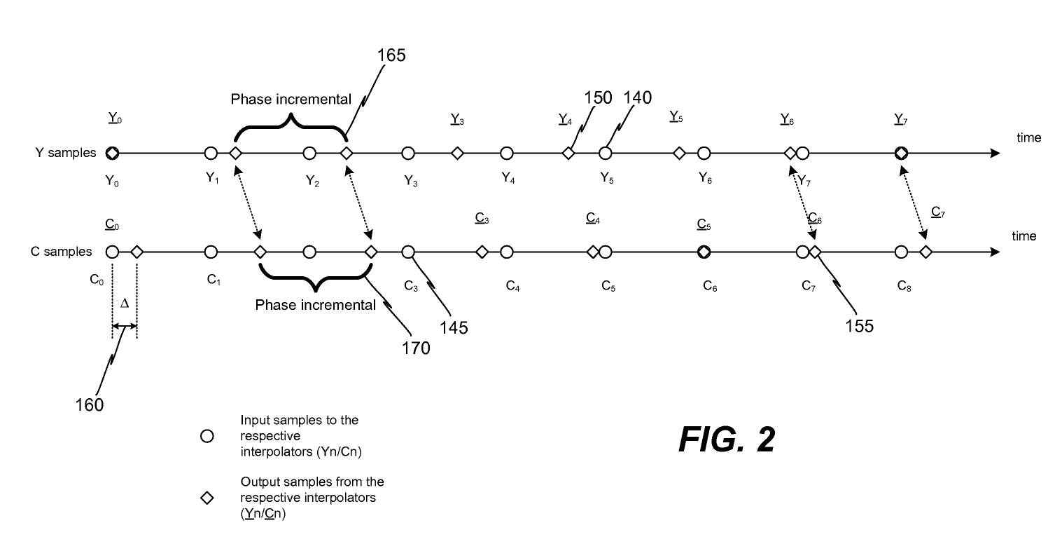

Referring also to FIG. 2, the interpolator 90 is configured to resample the signal received from the multiplexer 65 and/or delay the signal by a time amount Δ. Δ corresponds to a time interval 160, which corresponds to the amount of precision delay desired by a user of the system 5. For example, the system 5 can delay the luma signal 35 relative to the chroma signal 40 by a about 72.525 ns. About 72.105 ns of delay is provided by the coarse delayline module (e.g., τ is about 72.105 ns). The remaining delay provided by the interpolator 90, (e.g., Δ) is about 420 ps. The operation of the interpolator 95 is similar to that of the interpolator 90. Preferably, the precision delayline module 25 is configured to delay a selected one of the signals received from the multiplexers 65 and 70, using the interpolators 90 and 95, respectively, although other configurations are possible.

The interpolator 90 is configured to resample and/or provide the precision delay of the luma signal 45 using interpolation to select one of a fixed number of possible sample points between (or at) two input samples. The interpolator 90 is configured to receive the output of the multiplexer 65 (e.g., either the luma signal 45 or a delayed version of the luma signal 45), which has luma input samples 140 (Y₁, Y₂, . . . ) obtained from the ADC 10. The interpolator 90 is configured to delay and/or resample (e.g., upsample or downsample) the signal 45 to produce luma output samples 150 corresponding to the luma input samples 140 using polyphase interpolation. Likewise, the interpolator 95 is configured to receive the output of the multiplexer 70 (e.g., either the chroma signal 50 or a delayed version of the chroma signal 50), which has chroma input samples 145 (C₁, C₂, . . . ) obtained from the ADC 15. The interpolator 95 is configured to delay and/or resample (e.g., upsample or downsample) the signal 50 to produce chroma output samples 155 corresponding to the chroma input samples 150 using polyphase interpolation.

The coarse delayline module 20 introduces unequal delay to the luma and chroma signals such that different sample pairs may be aligned in time at the input to the interpolators 90, 95 versus at the input to the coarse delayline module 20 from the ADCs 10, 15. For example, if the coarse delayline module 20 delays the luma signal 45 by two clock cycles relative to the chroma signal, then Y₃ and C₃ are in temporal alignment at the inputs to the interpolators 90, 95 while Y₁ and C₃ are in temporal alignment at the input to the coarse delayline module 20.

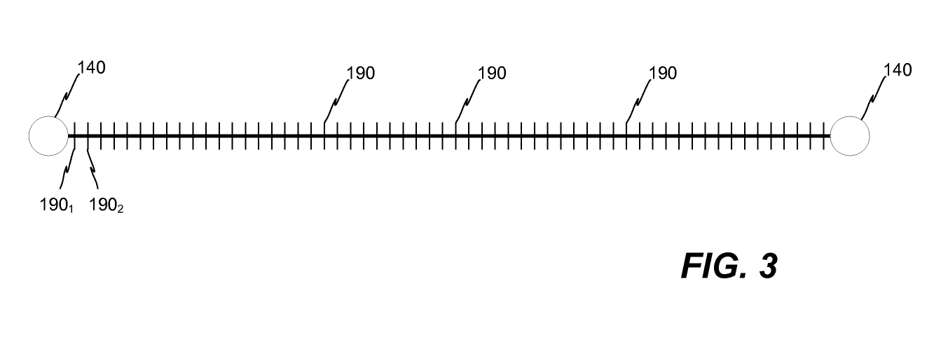

While the following discussion will focus on the configuration and operation of the interpolator 90, the operation and configuration of the interpolator 95 is similar. Referring also to FIG. 3, the temporal locations at which a luma output sample 150 can be generated by the interpolator 90, relative to the surrounding luma input samples 140, are the sample locations 190. The quantity of the sample locations 190 corresponds to the resolution of the interpolator 90. For example, a 256-phase interpolator is capable of generating one of the luma output samples 150 at one or more of 256 locations (relative to two consecutive ones of the input samples 140), including at the input samples 140. The time difference between adjacent ones of the sample locations 190 (e.g., 190₁ and 190₂) is a function of the resolution (e.g., the quantity of filter coefficient sets) of the interpolator 90 and the clock speed at which the interpolator 90 is operating. For example, because the interpolator 90 is a 256-phase polyphase interpolator operating using a 27.737 MHz clock signal, the interpolator 90 is capable of adjusting the phase of the input samples by about integer multiples of 140 ps according to:

$$\frac{( \frac{1}{Clock\_speed} )}{Interpolator\_resolution} = \frac{( \frac{1}{27.737 x {10}^{6}} )}{256} ≅ 140 x {10}^{- 12} . \qquad ( 1 )$$

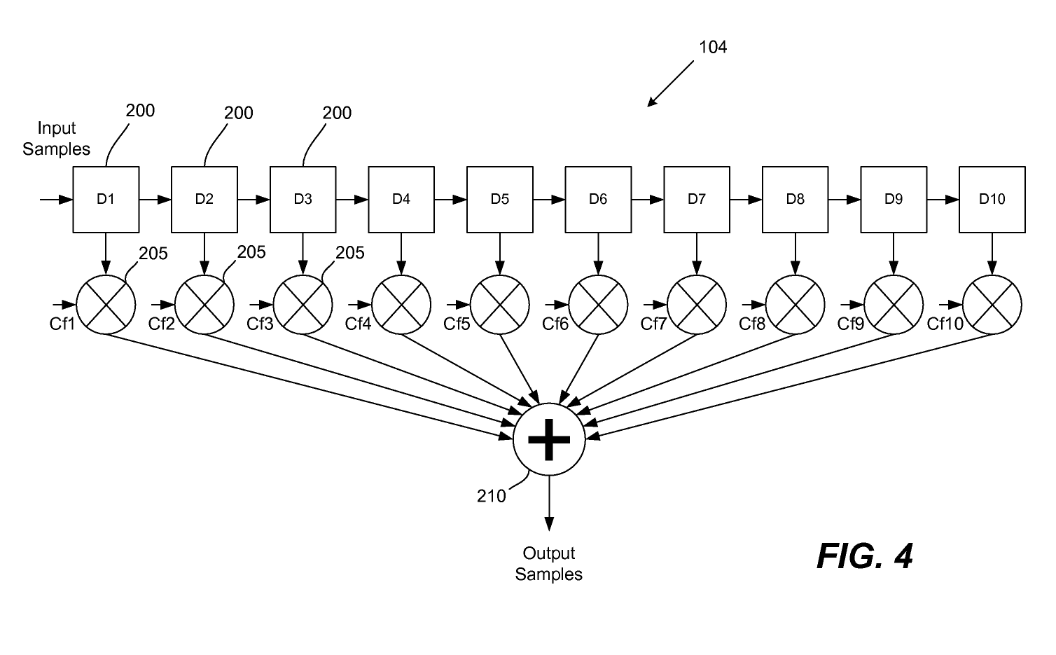

Referring also to FIG. 4, the interpolator 90 is configured to perform interpolation using a filter 104 including flip flops 200 (e.g., D1 through D10), multipliers 205, and a summator 210. The flip flops 200 are configured to receive luma input samples 140 from the multiplexer 65. The flip flops 200 are configured such that as a series of luma input samples 140 (e.g., Y₀, Y₁, Y₂, . . . ) arrive from the multiplexer 65, each respective luma input sample progresses through each of the flip flops 200, thus acting as a shift register. For example, when Y₀ arrives at the filter 104 it is stored in the flip flop D1; when Y₁ arrives at the filter 104, Y₀ is moved to the flip flop D2 and Y₁ is moved to the flip flop D1; and when Y₂ arrives the filter 104, Y₀ is moved to the flip flop D3, Y₁ is stored in the flip flop D2, and Y₃ is stored in the flip flop D1, etc. The multipliers 205 are configured to multiply the luma input samples contained in each respective flip flop 200 by respective filter coefficients (e.g., Cf1 through Cf10). Preferably, the interpolator 90 includes a quantity of filter coefficients corresponding to the phase resolution of the interpolator 90. For example, a 256-polyphase interpolator can include 256 sets of filter coefficients where each set of filter coefficients corresponds to one of the phases of the interpolator 90. The interpolator 90 is configured to select the filter coefficients (thereby, through operation of the filter 104, interpolating a new output sample) using a signal provided by the sample synchronizer 100 (as described below). The summator 210 is configured to add the outputs of each respective multiplier 205 and provide a summator output.

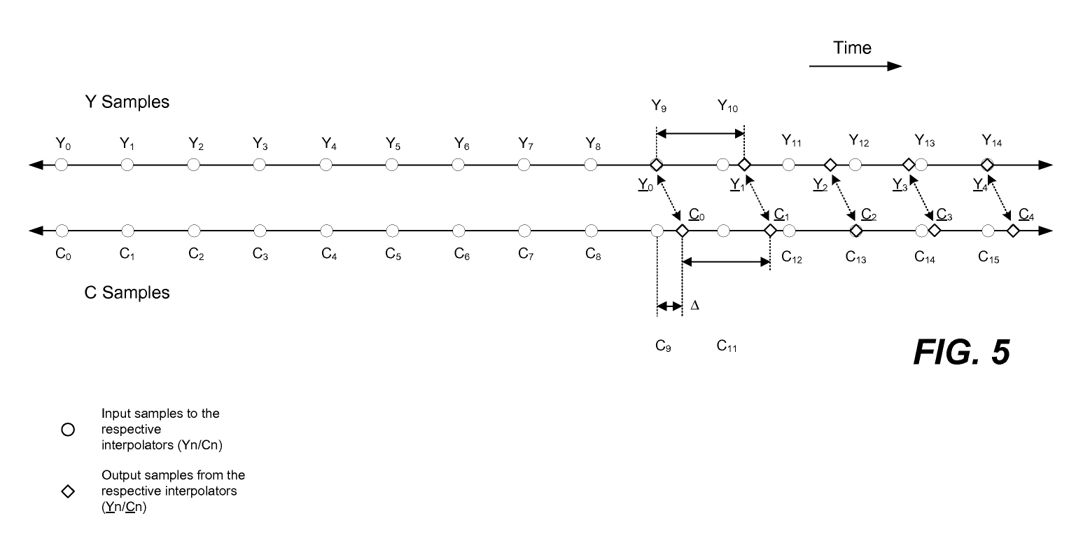

The interpolator 90 is configured to interpolate each of the luma output samples 150 by performing polyphase interpolation using a quantity (e.g., 10) of the luma input samples 140. The quantity of input samples used to generate each output sample can correspond to the quantity of the flip flops 200, though other configurations are possible. As an example of the operation of the interpolator 90, to generate the luma output sample Y₄, input samples Y₀, Y₁, Y₂, Y₃, Y₄, Y₅, Y₆, Y₇, Y₈, and Y₉ are used (e.g., Y₄ corresponds to a luma output sample 150 for a time between the luma input samples Y₄ and Y₅). Thus, to generate a luma output sample at a time T, the five luma input samples 140 before and the five luma input samples 140 after the time T are used. Thus, in implementation, the interpolator 90 is configured to output Y₄ after receiving all of the samples Y₀ through Y₉ (e.g., as shown in FIG. 5). The interpolator 90 is configured to operate by varying the coefficients Cf1 through Cf10 used by the multipliers 205. Each set of filter coefficients corresponds to an output sample interpolated at one of the sample locations 190. Preferably, the coefficients Cf1 through Cf10 are chosen such that the filter 104 is a “center tap” filter (e.g., the multipliers 205 corresponding to the flip flops D5 and D6 use a filter coefficient closer to one than the other multipliers 205), although other configurations are possible.

Referring to FIG. 2, an amount of time between subsequent ones of the luma output samples 150 is referred to as the phase increment (and likewise for subsequent ones of the chroma output samples 155). For example, a phase increment 165 refers to the amount of time between subsequent ones of the luma output samples 150 (e.g., Y₁ and Y₂) and a phase increment 170 refers to the amount of time between subsequent ones of the chroma output samples 155 (e.g., C₁ and C₂). While the phase increment between subsequent sample sets can vary (e.g., the phase increment between Y₁ and Y₂ can be different from the phase increment between Y₂ and Y₃), the phase increments between corresponding sample sets should be substantially equal (e.g., the phase increments between sample set Y₁ and Y₂, and between the set C₁ and C₂, respectively, should be substantially equal).

The sample synchronizer 100 is configured to control the operation of the interpolators 90 and 95. The sample synchronizer 100 is configured to control the generation of output samples by the interpolators 90 and 95, control when the interpolators 90 and 95 load/store signals provided by the coarse delayline module 20, set an initial phase of the luma and chroma signals at startup, and update the phase of the luma and chroma signals during operation.

The sample synchronizer 100 is configured to control when the interpolators 90 and 95 generate output samples using a clock signal provided by a numeric crystal oscillator (NCO) 30 via a connection 137. The sample synchronizer 100 is configured to use the NCO clock signal to produce the output samples. The NCO 30 is configured to generate a range of output sampling frequencies using a single fixed input sampling frequency (e.g., 27.737 MHz). The frequency of the output sampling signal can be fixed and/or user programmable. For example, if the ratio of the fixed input sampling to the NCO clock (output sampling) signal is 1.25, then the phase interpolator 90 will downsample the luma input samples 140 at a rate of eighty percent (e.g., four output samples are generated for every five input samples).

The sample synchronizer 100 is configured to control the loading/storage of the luma input samples 140 and the chroma input samples 145 in the interpolators 90 and 95, respectively. Each of the luma input samples 140 corresponds to a specific one of the chroma input samples 145 (e.g., Y₁ corresponds to C₁). As respective pairs of the luma input samples 140 and the chroma input samples 145 are transmitted by the multiplexers 65 and 70, respectively, the sample synchronizer 100 shifts the pair of input samples into the flip-flops 200 of the respective interpolators 90 and 95.

The phase of an output sample from the interpolators 90 and 95 depends on the position of the output sample, in time, relative to the surrounding input samples. For example, an output sample 150 corresponding in time to a first one of two consecutive input samples 140 has a phase of 0.0 (e.g., Y₀ relative to Y₀ and Y₁); an output sample 150 corresponding to a time half-way between two successive input samples 140 has a phase of 0.5; and an output sample 150 corresponding in time to a second one of two consecutive input samples 140 has a phase of 1.0 (e.g., Y₇ relative to Y₆ and Y₇). An output sample 150 occurring after a second one of two consecutive input samples 140 would have a phase greater than 1.0 (e.g., C₆ relative to C₆ and C₇). The phase measurement is independent of the amount of time between two successive input samples 140, 145 (e.g., the phase measurement is normalized). For example, the phase of an output sample 150 half-way between two surrounding input samples 140 would be 0.5 regardless of whether the two surrounding input samples 140 were 25 ps apart or 100 ps apart.

The sample synchronizer 100 is configured to establish initial phases, corresponding to the luma input samples 140 and the chroma input samples 145, during startup of the system 5. The sample synchronizer 100 is configured to set the initial phase as 0.0 for the undelayed one of the luma input samples 140 and the chroma input samples 145 (e.g., in FIG. 2, the initial phase of the luma output sample Y₀ is 0.0). Likewise, the sample synchronizer 100 is configured to set the initial phase of the delayed one of the luma input samples and the chroma input samples 145 (e.g., in FIG. 2, the chroma input samples 145) as:

$$0.0 + \frac{Δ}{{T}_{s}} , \qquad ( 2 )$$

where Tₛ is the sampling period of the input samples and Δ is the desired precision delay as described above. Δ is a programmable non-negative value. When Δ is applied to the chroma channel, a delay in time can be conceptually introduced to the luma channel, relative to the chroma channel. Similarly, when Δ is applied to the luma channel, then a delay in time can be conceptually introduced to the chroma channel, relative to the luma channel. The sample synchronizer 100 is configured to store the initial phase values in the memory 103. The sample synchronizer 100 is configured to use information provided by the delay path selector 75 to set the appropriate initial phases.

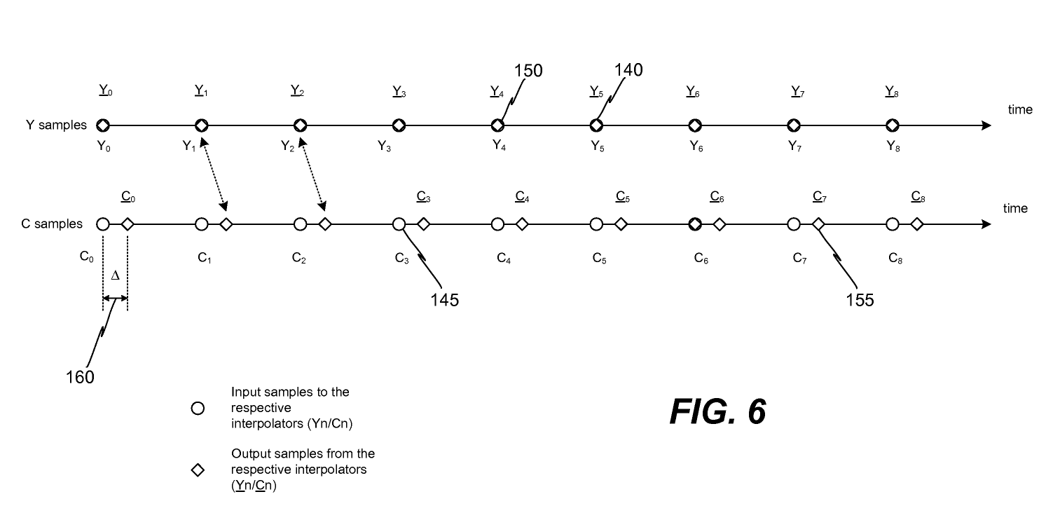

The sample synchronizer 100 is configured to update the phase values stored in the memory 103 after generating a pair of output samples, which controls when the next pair of output samples is generated. If no resampling is performed by the precision delayline module 25 (e.g., the luma output samples 150 are produced at the same rate as the luma input samples 140), the sample synchronizer 100 is configured to maintain the existing phase values (e.g., the phase value stored in memory is not updated). For example, in FIG. 6, the luma output samples 150 and the chroma output samples 155 are generated at the same temporal location each time, and thus the phases remain the same. If resampling is performed by the precision delayline module 25, the sample synchronizer is configured to update the stored phase values to reflect when the next output sample should be produced. For example, as described above, the sample synchronizer 100 can be configured to set the initial phases corresponding to Y₀ and C₀ to 0.0, and 0.25, respectively, and to downsample the signals at a rate of 87.5% (i.e., seven output samples are produced for every eight input samples). When the output samples Y₀ and C₀ are produced, the sample synchronizer 100 is configured to increment the phases stored in the memory by about 0.143 (i.e., 1/7^{th}). Thus, the stored phases corresponding to Y₀ and C₀ become about 0.143 and 0.393, respectively.

Referring to FIGS. 1-4, the sample synchronizer 100 is configured to control generation of output samples by the interpolators 90 and 95 by controlling the filter coefficients used by the interpolators 90 and 95 to generate the output samples. The sample synchronizer 100 is configured to determine the temporal position of an output sample relative to the surrounding input samples (e.g., Y₃ relative to Y₃ and Y₄) by fetching the phase information stored in the memory 103. Each of the sample locations 190 has a corresponding set of filter coefficients. The sample synchronizer 100 is configured to determine the set of filter coefficients corresponding to the position of the output sample 150, 155 relative to the surrounding input samples 140, 145. The sample synchronizer 100 is configured to provide the respective filter coefficients to the interpolators 90 and 95, or to instruct the interpolators 90 and 95 to fetch the respective filter coefficients from a memory. With the proper filter coefficients, the interpolators 90 and 95 can generate the desired output samples.

The sample synchronizer 100 is configured to synchronize the phase increment between respective pairs of the luma output samples 150 and pairs of the chroma output samples 150. For example, as described above, the phase increment between a successive pair of the luma output samples 150 (e.g., Y₁ and Y₂) should be substantially equal to the phase increment between a corresponding successive pair of the chroma output samples 155 (e.g., C₁ and C₂). Thus, before generating a set of output samples, the sample synchronizer 100 is configured to determine the phase of the next luma and chroma output samples 150, 155 to be produced. The sample synchronizer 100 is configured to retrieve the respective phase values from the memory 103. For example, during the process of generating Y₀, the sample synchronizer 100 is configured to retrieve the phase of Y₀ from the memory 103, which is 0.0 (which, here, happens to be the initial phase set during startup). The sample synchronizer 100 is configured to determine if each of the retrieved phases is less than 1.0. If the phase is less than 1.0 for the next one of the luma output samples 150, the sample synchronizer 100 will determine the appropriate set of filter coefficients (e.g., the sample synchronizer 100 selects one of the 256 sets of filter coefficients) to generate the next one of the luma output samples 150. Likewise, if the phase if less than 1.0 for the next one of the chroma output samples 155, the sample synchronizer is configured to determine the appropriate set of filter coefficients to generate the next one of the chroma output samples 155.

If the phase for either the next luma output sample 150 or the next chroma output sample 155 is greater than 1.0, the sample synchronizer 100 corrects for a mismatch of the input and output samples by delaying the luma or chroma output sample 150, 155. If the phase is greater than 1.0, then the corresponding one of the luma output samples 150 or the corresponding one of the chroma output samples 155 would be generated using unrelated (and therefore mismatched) sets of the input samples. For example, the output luma sample Y₆ corresponds to the chroma output sample C₆. The chroma output sample C₆, however, will not be ready within a time Δ of the luma output sample Y₆ because an additional one of the chroma input samples 145 is received before C₆ can be generated. The interpolator 90 uses the luma input samples Y₂ through Y₁₁ to interpolate the luma output sample Y₆. When luma output sample Y₆ is ready to be produced, however, an additional one of the chroma input samples 155 (e.g., C₁₂) should be received in order for the interpolator 95 to interpolate the chroma output sample C₆. Thus, the sample synchronizer 100 will delay the interpolator 90 from outputting the luma output sample Y₆ until the corresponding chroma sample, C₆, is ready. For example, once C₆ is ready, the sample synchronizer 100 is configured to cause the interpolator 90 to output Y₆, wait a time period Δ, and cause the interpolator 95 to output C₆. Thus, each of the respective output samples (e.g., Y₆ and C₆) has the same phase increment relative to the previous respective output samples (e.g., Y₅ and C₅).

The sample synchronizer 100 is configured to normalize the phase values and to generate the enable signal on the enable clock output 125. The sample synchronizer 100 is configured to normalize the phase values stored in the memory 103 by subtracting 1.0 from the phase value if the phase value is greater than 1.0. For example, when the luma input sample Y₇ arrives at the interpolator 90, Y₆ has a phase equal to about 0.83 and C₆ has a phase equal to about 1.08. Once the last of the chroma inputs samples used to generate C₆ (here, C₁₂) arrives at the interpolator 95, the sample synchronizer 100 updates the phase value for C₆ to about 0.08 (e.g., by decrementing it by 1.0) and generates C₆ using C₃ through C₁₂. Furthermore, the sample synchronizer 100 is configured to generate an enable pulse each time a pair of output samples is produced by the interpolators 90 and 95 and output the pulse on the line 125.

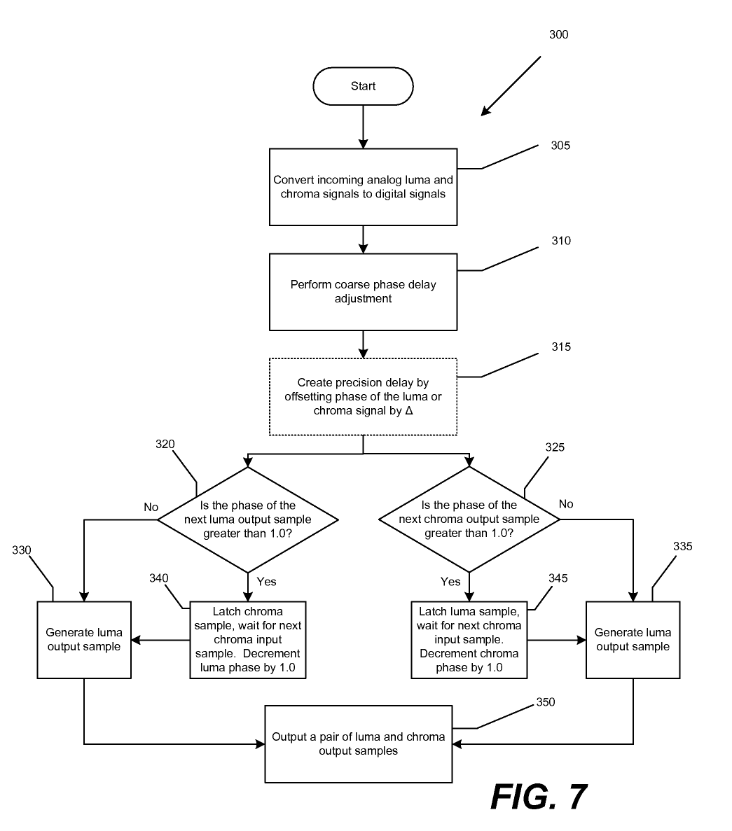

In operation, referring to FIG. 7, with further reference to FIGS. 1-4, a process 300 for providing high-precision delay adjustment using the system 5 includes the stages shown. The process 300, however, is exemplary only and not limiting. The process 300 can be altered, e.g., by having stages added, removed, or rearranged.

At stage 305, the incoming analog luma and chroma signals are converted into respective digital luma and chroma signals, respectively. The ADC 10 converts the luma signal 35 into a digital luma signal 45 using a sampling frequency of 27.737 MHz. The ADC 15 converts the chroma signal 40 into a digital chroma signal 50 using a sampling frequency of 27.737 MHz. While a sampling frequency of 27.737 MHz has been described, other sampling frequencies can be used. If the luma signal 35 and the chroma signal 40 are digital signals, stage 305 can be omitted.

At stage 310, coarse delay adjustment is performed by the coarse delayline module 20. The coarse delayline module 20 receives the luma signal 45 and the chroma signal 50. The multiplexer 55 provides either the luma signal 45 or the chroma signal 50 to the buffer 60 via the output 58 under control of the selector 75. The buffer 60 is configured to delay the luma signal 45 (or the chroma signal 55) for the time τ relative to the chroma signal 55 (or luma signal 55). The buffer 60 provides the luma signal 45 (or chroma signal 55) to the multiplexers 65 and 70, that output delayed or undelayed luma and chroma signals in accordance with indicia from the selector 75. If the multiplexer 55 provides the luma signal 45 to the buffer 60, then the multiplexer 65 provides the delayed version of the luma signal 45 to the output 68 and the multiplexer 70 provides the undelayed chroma signal 50 to the output 73. Likewise, if the multiplexer 55 provides the chroma signal 50 to the buffer 60, then the multiplexer 65 provides the undelayed luma signal 45 to the output 68 and the multiplexer 70 provides the delayed version of the chroma signal 50 to the output 73. Alternatively, if no coarse delay adjustment is desired, the multiplexer 65 provides the undelayed luma signal 45 to the output 68 and the multiplexer 70 provides the undelayed chroma signal 50 to the output 73. At stage 315, the initial phases of the luma output samples 140 and the chroma output samples 150 are stored in the memory 103 by the sample synchronizer 100. The sample synchronizer 100 is configured to offset a selected one of the luma or chroma phase values by a time amount Δ/Tₛ, corresponding to the desired phase delay. After initialization of the system, the stage 315 can be omitted.

At stage 320, the sample synchronizer 100 retrieves the phase of the next luma output sample to be generated from the memory 103. The sample synchronizer 100 determines if the phase of the next luma output sample is greater than 1.0. If the phase is greater than 1.0, the process 300 proceeds to stage 340, otherwise the process 300 proceeds to stage 330.

At stage 325, the sample synchronizer 100 retrieves the phase of the next chroma output sample to be generated from the memory 103. The sample synchronizer 100 determines if the phase of the next chroma output sample is greater than 1.0. If the phase is greater than 1.0, the process 300 proceeds to stage 345, otherwise the process 300 proceeds to stage 335.

At stage 330, the sample synchronizer 100 causes a luma output sample to be generated by the interpolator 90. The sample synchronizer 100 indicates to the interpolator 90 which set of filter coefficients to use in order to interpolate the next luma output sample. The multipliers 205 multiply the contents of each one of the flip flops 200 (e.g., D1 through D10) by a respective filter coefficient (e.g., Cf1 through Cf10). The summator 210 adds the outputs of the multipliers 205 to generate a luma output sample.

At stage 335, the sample synchronizer 100 causes a chroma output sample to be generated by the interpolator 95. The sample synchronizer 100 indicates to the interpolator 95 which set of filter coefficients to use in order to interpolate the next chroma output sample. The multipliers 205 multiply the contents of each one of the flip flops 200 by a respective filter coefficient. The summator 210, adds the outputs of the multipliers 205 to generate a chroma output sample.

At stage 340, the sample synchronizer 100 causes the interpolator 95 to temporarily hold (e.g., latch) a generated luma output sample (e.g., generated in accordance with stage 335). The sample synchronizer 100 waits for the next set of luma and chroma input samples to arrive at the interpolators 90 and 95, respectively. The sample synchronizer 100 decrements the phase value for the output luma sample stored in the memory 103 by 1.0. After stage 340, the process 300 proceeds to stage 330 where a luma output sample is generated using the updated (e.g., decremented) phase value.

At stage 345, a generated chroma synchronizer 100 causes the interpolator 90 to temporarily hold output sample (e.g., generated in accordance with the stage 330). The sample synchronizer 100 waits for the next set of luma and chroma input samples to arrive at the interpolator 90 and 95, respectively. The sample synchronizer 100 decrements the phase value for the output chroma sample stored in the memory 103 by 1.0. After stage 345, the process 300 proceeds to stage 335 where a chroma output sample is generated using the updated phase value.

At stage 350, the sample synchronizer 100 causes the interpolators 90 and 95 to output the luma and chroma samples generated during the stages 330 and 335, respectively, in accordance with the desired delay. The sample synchronizer 100 provides an enable pulse via the enable clock output 125.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

While the invention has been described in the context of chroma and luma signals, other signals can be processed. For example, the system 5 can be used with a YPbPr and/or an RGB signal having three signal paths. To provide high precision delay on more than two signal paths, additional hardware, such as additional multiplexers and interpolators, can be used.

While the invention has been described as performing polyphase interpolation using ten of the input samples, other interpolation methods and/or quantities can be used to generate the output samples.

While the invention has been described in the context of intentionally introducing a preemptive delay (e.g., to compensate for a later delay path delay), with additional hardware, the system can also correct for synchronization loss caused earlier in the signal stream.

Further, while the description above refers to the invention, the description may include more than one invention.

What is claimed is:

1. A system for synchronizing video signals using a sampled signal having a sampling cycle, the system comprising:
a coarse offset module configured to receive a first input signal and a second input signal and to alter an offset of the first and second input signals to produce a first intermediate signal and a second intermediate signal offset relative to each other by an integer multiple of the sampling cycle; and
a fine offset module coupled to the coarse offset module to receive the first and second intermediate signals and configured to alter an offset between the first and second intermediate signals relative to each other by an amount less than the sampling cycle to produce a first output signal and a second output signal.

2. The system of claim 1 wherein the fine offset module includes an interpolator.

3. The system of claim 2 wherein the interpolator is configured to resample the first and second intermediate signals.

4. The system of claim 2 wherein the interpolator is configured to use polyphase interpolation.

5. The system of claim 2 wherein the interpolator is configured to use N input samples of the first intermediate signal to produce a single sample of the first output signal, and configured to use N input samples of the second intermediate signal to produce a single sample of the second output signal.

6. The system of claim 5 wherein N=10.

7. The system of claim 2 wherein the fine offset module includes a synchronizer configured to synchronize the loading of input samples of the first intermediate signal and the second intermediate signal into the interpolator.

8. The system of claim 1 wherein the fine offset module includes a synchronizer configured to synchronize a phase increment between respective pairs of samples of the first and second output signals.

9. The system of claim 1 wherein the fine offset module includes a synchronizer configured to delay an output sample of the first output signal until a corresponding output sample of the second output signal is ready to be output.

10. A method for synchronizing video signals using a sampled signal having a sampling cycle, the method comprising:
receiving a first input signal and a second input signal at a coarse offset module;
producing a first intermediate signal and a second intermediate signal by altering an offset of the first and second input signals, the first and second intermediate signals being offset relative to each other by an integer multiple of a sampling cycle; and
producing a first output signal and a second output signal by altering an offset between the first and second intermediate signals relative to each other by an amount less than the sampling cycle.

11. The method of claim 10 wherein producing a first output signal and a second output signal includes interpolating the first and second output signals.

12. The method of claim 10 further including resampling the first intermediate signal.

13. The method of claim 11 wherein interpolating the first and second output signals includes interpolating the first and second output signals using polyphase interpolation.

14. The method of claim 11 wherein producing the first and second output signals includes using N input samples of the first intermediate signal to produce a single sample of the first output signal, and includes using N input samples of the second intermediate signal to produce a single sample of the second output signal.

15. The method of claim 14 wherein N=10.

16. The method of claim 10 further including synchronizing a phase increment between respective pairs of samples of the first and second output signals.

17. The method of claim 10 further including delaying an output sample of the first output signal until a corresponding output sample of the second output signal is ready to be output.
